(19) United States
(12) Patent Application Publication
(10) Pub. No.: US 2010/0003374 A1
(43) Pub. Date: Jan. 7, 2010

(54) Edible maze

(76) Inventor: Jeff Hachmann, Stowg, VT (US)

Correspondence Address: Green Mountain Innovations LLC;Alan Cote, P.O. Box 248, Williston, VT, 05495, US

(21) Appl. No.: 12/217,010

(22) Filed: Jul. 1, 2008

(51) Int. Cl. A23G 3/50

(52) U.S. Cl. 426/104

(57) ABSTRACT

The invention describes an edible confectionary item molded in the form of a maze. One planar surface of the confectionary item is formed with indented grooves to create a maze, or labyrinth pattern. The perimeter of the planar surface of the confectionary item is raised to form an outside ridge. There also exists a movable piece, such as a ball, which can be navigated through the maze pattern by tilting and tapping the confectionary item. A further indentation within the maze forms a starting point for the movable piece. There also exists a destination point of the maze, which may be demarcated in any number of ways. The destination may include an image such as a corporate logo, letters, a geographical representation such as a city, or other suitable promotional identifiers.

### CROSS-REFERENCE TO RELATED APPLICATION

Filed concurrently with a design patent which claims the ornamental design of the invention disclosed in this application.

### FEDERALLY-SPONSORED RESEARCH

None

### SEQUENCE LISTING

None

### BACKGROUND OF THE INVENTION

1. Field of the Invention

The present invention relates to the field of edible novelty products, specifically in the form of a maze or labyrinth. A feature of the invention is the destination, or finishing-point of the maze, where the destination may include a promotional identifier such as a corporate logo or a geographic representation such as a city. A movable piece capable of traveling through the maze is included.

2. Description of Related Art

There exists numerous types of designs for confectionary items in the marketplace and in US Patents. U.S. D446,627 shows a design for a candy in the shape of an animal, embossed with a simple pattern. Pat. D373,232 and D509,341 show other examples of different patterns appearing on food products. Other patterns, which may contain grooves or pathways, are also known for food products.

Small mazes, usually made of wood or molded plastic, including a ball that can be rolled about within the maze, have been commonplace for many years as articles of amusement.

While these mazes serve as amusement devices, such mazes have not featured an end point, or destination, where the destination serves as a promotional tool in conjunction with the maze. The added feature of the maze with a promotional destination being edible, furthers the novelty aspect. Therefore, what is needed, is an edible item which includes a destination that can be used for promotional purposes.

### BRIEF SUMMARY OF THE INVENTION

In the preferred embodiment, the edible novelty product is a confectionary item such as chocolate. A variety of overall shapes for the confectionary item can be employed, such as an oval, square, or triangle. Additional dedicated shapes such as those of a US State, or the shape of a corporate logo, may also be used.

One or more of the planar surfaces of the confectionary item is formed with indented grooves to create a maze, or labyrinth pattern. The perimeter of the planar surface of the confectionary item is raised to form an outside ridge. There also exists a movable piece such as a ball, edible or inedible, which can be navigated through the maze pattern by tilting and tapping the confectionary item.

A further indentation or perforation within the maze forms a starting point for the movable piece in the maze. There also exists a destination point of the maze, which may be demarcated in any number of ways. One destination is simply an enclosed area. A different style destination is formed by either an indentation in the planar surface of the confectionary item. Another style destination uses a hole in which there is an absence of the confectionary item and which therefore allows a portion of the backing-card on which the confectionary rests to be visible. In all embodiments, the destination may include an image such as a corporate logo, letters, a geographical representation such as a city, or other suitable promotional identifiers.

### BRIEF DESCRIPTION OF THE SEVERAL VIEWS OF THE DRAWINGS

The attributes of the invention will be further understood when reviewed in conjunction with the drawings.

FIG. 1 is a top view of the edible novelty item.

FIG. 2a is a side view of the edible novelty item.

FIG. 2b is a end view of the edible novelty item.

FIG. 3 is a perspective view of the edible novelty item.

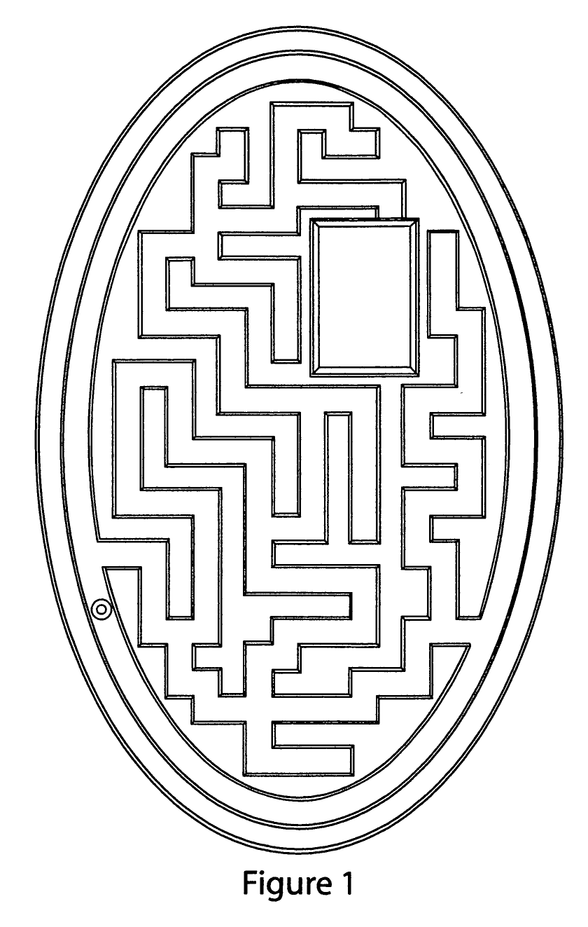

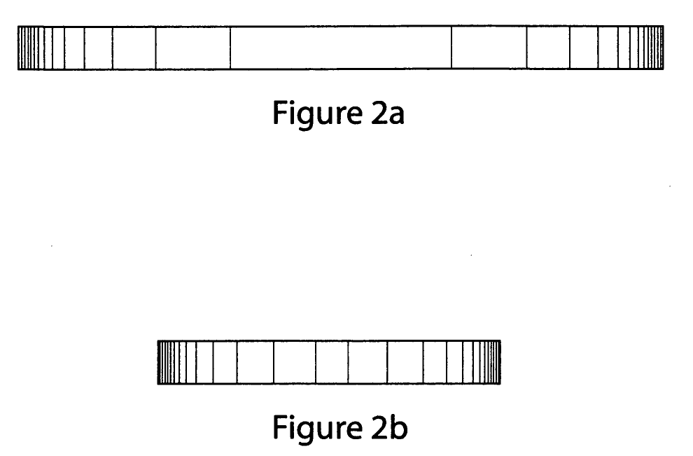

### DETAILED DESCRIPTION OF THE INVENTION

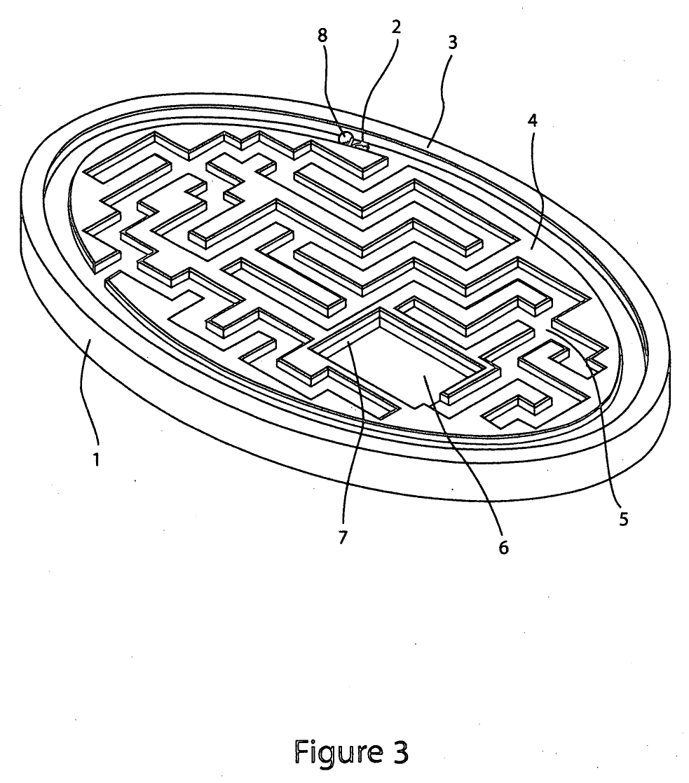

As can be seen by reference to the drawings, and in particular to FIG. 3, the edible novelty item includes the pattern of a maze. While a particular and distinct maze pattern is shown, it should be appreciated that there are a near-infinite number of possible maze patterns that could be used, the common element being that the maze pattern includes both a beginning and a destination. The term maze is used to describe a complex network of paths with choices such as intersections, some of which may lead to dead-ends. A labyrinth is sometimes defined as a winding single path which inevitably leads to the intended destination. Herein, the term maze is also intended to encompass a labyrinth and is used to describe both, for purposes of brevity.

The preferred embodiment is shown in the illustrations. FIG. 3 shows the overall edible item, designated by reference number 1. Starting point 2 is an indentation in the groove 3, with the starting point serving to cradle movable piece 8. An outside ridge 3 prevents movable piece 8 from moving off the edible product 1. The raised planar surface 4, in conjunction with the grooves represented by 5, together form the maze pattern. While groove 5 is shown at a single planar level, other embodiments may use multiple planar levels for groove 5, resulting in steps upward or downward within the maze pattern.

Destination 6 is bounded by end point walls 7. Destination 6 can be formed in a multitude of ways. In one embodiment, the planar surface of the destination is co-planar with the grooves of the maze. Another embodiment uses a destination with a planar surface lower than the planar surface of the grooves of the maze, which allows the movable piece to drop into the destination to clearly signify a successful navigation of the maze. Destination 6 may also be formed by a perforation in the planar surface of the edible product 1. Such a perforation allows the backing material on which edible product rests to be visible. The end point walls 7 may be of a sloped nature, such as a 45 degree bevel, or may be formed at a simple 90 degree angle.

In any of the possible versions of destination 6, an image may be included. The image could be in the form of a picture or pictures, letters, logo such as that of a company, geometric shape, or other identifier. The image may serve as a highlight of the promotion features of the edible item. For instance, a corporate logo could be placed at the destination, and the edible item given to potential customers of the corporation as a gift. Numerous other versions of the overall shape of the edible item can readily be employed, such as different geometric shapes like rectangles, triangles, or circles, or that of a US state, with the destination being the capital city or a particular location to visit such as a resort, with the destination marked by appropriate lettering or logo.

The image at destination 6 may be creating by a number of different methods. One method is a crack and peel sticker which may be applied to the planar surface of destination 6. Another method is to print the image directly on the edible item using edible ink. Images may be applied by other conventional, suitable methods. If a perforation of destination 6's planar surface is used as previously described, an image may be printed on the backing material on which the edible item rests. This method allows a common edible item to be manufactured, with customization for a specific corporation requiring only customized backing material. The image for destination 6 may also lie outside the area of destination 6 itself, and instead be formed on the adjacent planar surfaces surrounding destination 6.

A consumer of the invention can find amusement by tipping overall edible item 1 from side-to-side, causing movable piece 8 to travel through the maze to find destination 6. In the preferred embodiment, movable piece 8 is edible, such as a small confectionary ball. In the preferred embodiment, overall edible item 1 is made of chocolate. However, the invention is not limited to that type of edible material. Other confectionary materials such as hard candy could be used, as well as but not limited-to bakery-type dough which results in a cookie, biscuit, shortbread, or other similar edible item.

The manufacture of custom-shaped chocolates is well know by those skilled in the art, including both professional confectioners and home bakers. A mold in the desired overall edible item shape is made from material such as a suitable food grade rubber, plastic, or metal. Molten chocolate is then poured into the mold, and the mold released when the chocolate hardens sufficiently. Overall edible item 1 can be further adorned with contrasting elements such as chocolate of a different color, molded-in lettering, etc.

What is claimed:

1. An edible novelty item comprising:
a grooved maze pattern formed on a portion of at least one planar surface;
a raised ridge surrounding the perimeter of said maze pattern;
a movable piece capable of traveling through said maze pattern;
a maze destination.

2. The item as in claim 1 wherein the grooved maze pattern is formed on one planar surface.

3. The item as in claim 1 wherein the movable piece is spherical.

4. The item as in claim 1 wherein the movable piece is edible.

5. The item as in claim 1 wherein the maze destination is formed by a surface lower than the planar surface of said maze grooves.

6. The item as in claim 1 wherein the maze destination is a perforation in the planar surface thereby creating a localized absence of the planar surface.

7. The item as in claim 1 wherein the maze destination contains an image.

8. The item as in claim 1 wherein the planar surface that surrounds the maze destination contains an image.

9. The item as in claim 1 wherein the item is made of chocolate.

10. The item as in claim 1 wherein the item is made of bakeable dough.
